(19) United States
(12) Patent Application Publication
(10) Pub. No.: US 2007/0148466 A1
(43) Pub. Date: Jun. 28, 2007

(54) Multilayer film optical member and method for manufacturing multilayer film optical member

(76) Inventor: Toru Iwane, Yokohama (JP)

Correspondence Address: OLIFF & BERRIDGE, PLC, P.O. BOX 19928, ALEXANDRIA, VA, 22320, US

(21) Appl. No.: 10/589,356

(22) PCT Filed: Feb. 9, 2005
(86) PCT No.: PCT/JP05/01956

§ 371 Date: Aug. 11, 2006

(30) Foreign Application Priority Data
Oct. 2, 2004 (JP) 2004-034734

(51) Int. Cl. B32B 27/00; B29D 11/00

(52) U.S. Cl. 428/411.1; 428/910; 264/1.34; 264/1.38; 264/1.7

(57) ABSTRACT

A manufacturing method for manufacturing a multilayer film optical member, includes an injection step in which an UV-curable liquid crystal is injected into a space between a pair of transparent substrates, with a transparent conductive film disposed on each of the transparent substrates; a first radiation step in which parallel coherent ultraviolet light beams are radiated onto the UV-curable liquid crystal through the pair of transparent substrates from two sides of the UV-curable liquid crystal; and a second radiation step in which ultraviolet light achieving uniform intensity on a surface of the transparent substrate is radiated onto the UV-curable liquid crystal through the transparent substrate while applying an electrical field between the pair of transparent conductive films.

### TECHNICAL FIELD

The present invention relates to an optical member made up of a multilayer film constituted of light curable liquid crystal and a method for manufacturing such an optical member.

### BACKGROUND ART

A multilayer film at which light is reflected or transmitted depending upon its wavelength is normally manufactured through vapor deposition. Such a multilayer film includes at least two types of layers with varying optical characteristics alternately layered over multiple stages and is utilized as an optical film in a lens, an optical filter or the like. A similar multilayer polymer film adopting the interference method, which is referred to as a GBO (giant birefringent optics) film, is manufactured through a lamination method. The GBO film, formed by laminating over multiple stages thinly drawn polymer films, achieve optical anisotropy and thus, can be used when manufacturing an optical member having, for instance, polarization characteristics.

Japanese Laid Open Patent Publication No. 2002-139979 (patent reference literature 1) discloses a method for manufacturing multilayer film by mixing a non-light curable liquid crystal and a photopolymer liquid-state polymer material at a specific ratio and radiating ultraviolet laser with interference so as to create alternate liquid crystal and polymer layers.

### DISCLOSURE OF THE INVENTION

The multilayer film manufactured through the method disclosed in patent reference literature 1 by using the mixture of a liquid crystal and a liquid-state polymer material as described above may not achieve the desired optical characteristics if the liquid crystal and the liquid-state polymer material are not mixed uniformly or if there is an error in the mixing ratio. In addition, in order to accurately control the hardening reaction speed of the photopolymer liquid-state polymer material relative to its diffusion speed, it is necessary to blend a polymerization retardant, a sensitizer pigment or the like into the mixture of the liquid crystal and the liquid-state polymer material. Since these substances are impurities, the optical quality of the product is compromised. In other words, it is difficult to manufacture an optical member assuring a high optical quality.

A manufacturing method for manufacturing a multilayer film optical member according to a first aspect of the present invention, executes an injection step in which an UV-curable liquid crystal is injected into a space between a pair of transparent substrates, with a transparent conductive film disposed on each of the transparent substrates, a first radiation step in which ultraviolet light beams, each ultraviolet light beam being a parallel coherent light beam, are radiated onto the UV-curable liquid crystal through the pair of transparent substrates from two sides of the UV-curable liquid crystal; and a second radiation step in which ultraviolet light achieving uniform intensity on a surface of the transparent substrate is radiated onto the UV-curable liquid crystal through the transparent substrate while applying an electrical field between the pair of transparent conductive films.

A manufacturing method for manufacturing a multilayer film optical member according to a second aspect of the present invention, executes an injection step in which an UV-curable liquid crystal is injected into a space between a pair of transparent substrates; a first radiation step in which ultraviolet light beams, each ultraviolet light beam being a parallel coherent light beam, are radiated onto the UV-curable liquid crystal through the pair of transparent substrates from two sides of the UV-curable liquid crystal; and a second radiation step in which ultraviolet light achieving uniform intensity on a surface of the transparent substrate is radiated onto the UV-curable liquid crystal through the transparent substrate while holding in a magnetic field the UV-curable liquid crystal having been injected into the space between the pair of transparent substrates.

In a manufacturing method for manufacturing an UV-curable liquid crystal according to the second aspect, the second radiation step may be executed by selecting a desired orientation for the magnetic field relative to surfaces of the pair of transparent substrates.

In a manufacturing method for manufacturing an UV-curable liquid crystal according to the first or second aspect, it is preferable that during the first radiation step, an angle of incidence of light radiated onto the UV-curable liquid crystal from one side is set equal to an angle of incidence of light radiated from another side. The first radiation step may be executed by designating one of radiation intensity and a length of radiation time of light radiated onto the UV-curable liquid crystal from one side and one of radiation intensity and a length of radiation time of light radiated from another side as variables. It is preferable that the ultraviolet light achieving uniform intensity, that is radiated in the second radiation step, is non-coherent light. It is also preferable that after ending the second radiation step, a separation step in which the multilayer film optical member is separated from the transparent substrates is executed.

A third aspect of the present invention is a multilayer film optical member manufactured through the above described manufacturing method.

A multilayer film optical member according to a fourth aspect of the present invention includes a plurality of liquid crystal layers oriented along directions different from one another and layered one on top of another.

### BRIEF DESCRIPTION OF THE DRAWINGS

FIG. 1 is a partial sectional view schematically illustrating a multilayer optical film achieved in a first embodiment of the present invention;

FIG. 2 is a conceptual diagram of an index ellipsoid;

FIG. 3 is a partial sectional view of a liquid crystal cell, illustrating a first radiation step which is one of manufacturing steps executed to manufacture the multilayer optical film in the first embodiment of the present invention;

FIG. 4 is a schematic diagram of a structure adopted in an interference optical system used to execute the first radiation step;

FIG. 5 is a schematic diagram in reference to which a radiation angle assumed during the first radiation step is explained;

FIGS. 6(a) and 6(b) are schematic illustrations of a second radiation step, one of the manufacturing steps executed when manufacturing the multilayer optical film in the first embodiment of the present invention;

FIG. 7 is a partial sectional view schematically illustrating the multilayer optical film achieved in a second embodiment of the present invention; and

FIG. 8 is a schematic diagram illustrating a radiation step executed in a magnetic field, which is one of the manufacturing steps executed to manufacture the multilayer optical film in the second embodiment of the present invention.

### BEST MODE FOR CARRYING OUT THE INVENTION

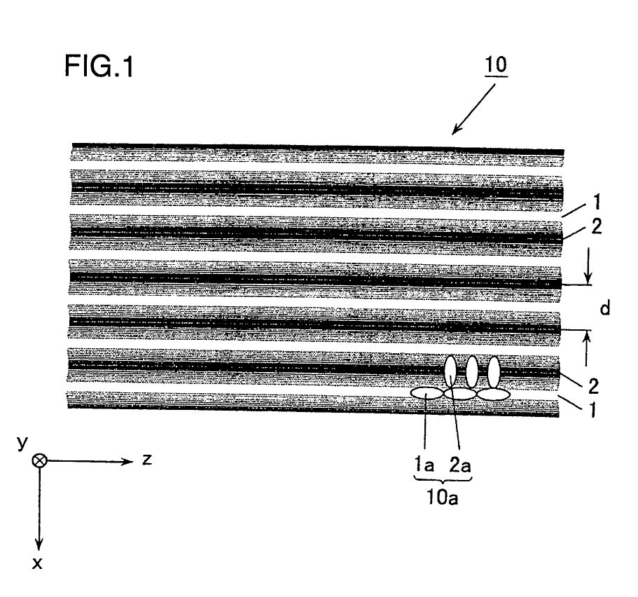

A multilayer film optical member and the method for manufacturing the multilayer optical member according to the present invention are now explained in reference to FIGS. 1 through 8.

### First Embodiment

FIG. 1 is a partial sectional view schematically illustrating the multilayer optical film achieved in the first embodiment of the present invention. FIG. 1 shows a multilayer optical film 10 in an orthogonal coordinate system with the thickness of the multilayer optical film 10 indicated along the x-axis.

As shown in FIG. 1, the multilayer optical film 10 is constituted with two types of layers with different optical characteristics, i.e., an A layer land a B layer 2 alternately layered with a layering pitch d over numerous stages. The thickness of the multilayer optical film 10 is several to 10 times as large as the thickness of a liquid crystal layer in a liquid crystal panel used for display purposes and may be set to, for instance, several tens to 100 μm. The A layer 1 and the B layer 2 are formed by hardening an UV-curable liquid crystal under varying hardening conditions so as to achieve optical characteristics different from each other.

The liquid crystal molecules in the UV-curable liquid crystal used in the first embodiment have uni-axial optical anisotropy and form uni-axial index ellipsoids. The major axes of index ellipsoids la constituting the A layer 1 are oriented parallel to the film surface (the z direction), whereas the major axes of index ellipsoids 2a constituting the B layer 2 are oriented along the thickness of the film (the x direction) Thus, the entire multilayer optical film 10 achieved by cyclically layering the A layer 1 and the B layer 2 with the varying optical characteristics manifests optical anisotropy. It is to be noted that reference numeral 10a is assigned to collectively refer to the index ellipsoids 1a and 2a.

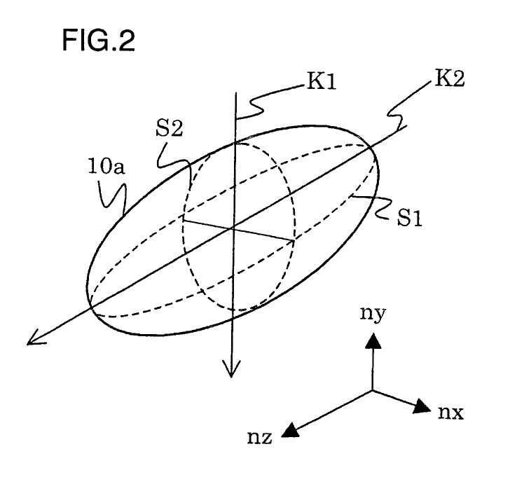

In reference to FIG. 2, the characteristics of the index ellipsoids 10a are explained. An index ellipsoid 10a is a uni-axial crystal. Assuming that nx, ny and nz respectively represent its refractive indices along the x direction, the y direction and the z direction, the refractive indices nx and ny are equal to each other, whereas the refractive index nz along the major axis (along the z direction) of the index ellipsoid 10a differs from nx and ny. Let us now consider a situation in which incoming light K1 enters the index ellipsoid parallel to the y direction and incoming light K2 enters the ellipsoid parallel to the z direction. S1 indicates an elliptical plane obtained by cutting the index ellipsoid 10a across with a plain ranging through the center of the index ellipsoid 10a and perpendicular to the incoming light K1. S2 indicates a circular plane obtained by cutting across the index ellipsoid 10a with a plane ranging through the center of the index ellipsoid 10a and perpendicular to the incoming light K2. The index ellipsoid 10a assumes two different refractive indices for the incoming light K1, each in correspondence to a specific polarizing direction. Namely, if the incoming light K1 is polarized along the z direction, the refractive index nz is assumed, whereas if the incoming light K1 is polarized along the x direction, the refractive index nx is assumed. In addition, the index ellipsoid 10a assumes the refractive index nx (=ny) for the incoming light K2 regardless of the polarizing direction.

When polarized light enters the multilayer optical film 10 in FIG. 1 at a right angle, the multilayer optical film 10 functions as a multilayer film with the A layer 1 with the refractive index nz and the B layer 2 with the refractive index nx layered alternately to each other as long as the light is polarized parallel to the z direction, whereas the multilayer optical film functions as a single-layer film with the refractive index nx if the light is polarized parallel to the y direction.

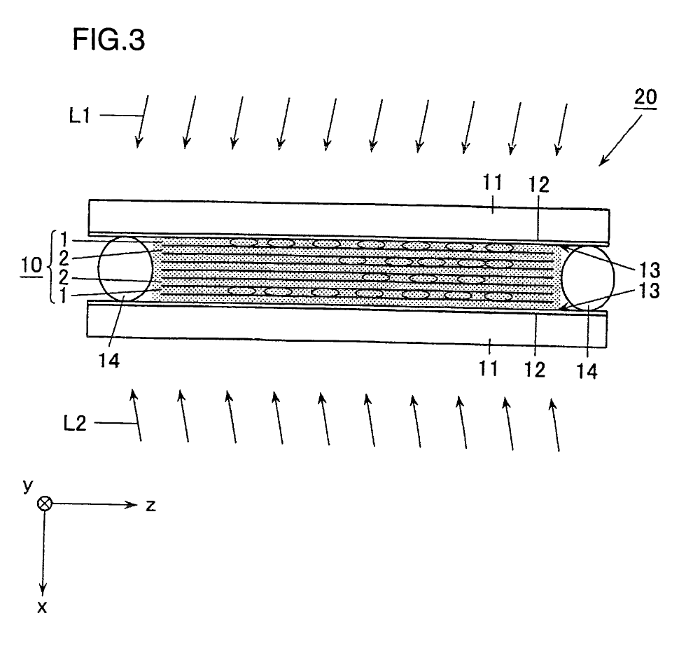

The following is an explanation of the method adopted to manufacture the multilayer optical film 10 in the embodiment, given in reference to FIGS. 3 through 5. Prior to the liquid crystal injection, a transparent conductive film 12 such as an ITO (indium-tin oxide) film is formed at the inner side surfaces of a pair of glass substrates 11, an orientation film 13 such as a polyimide polymer film is coated onto each transparent conductive film 12 and orientation processing such as rubbing is executed on the orientation films 13. In addition, after disposing spacer 14 at the inner side surface of one of the glass substrate 11 by, for instance, scattering and fixing polystyrene polymer spheres onto the inner side surface, a glass cell constituted with the two glass substrates 11 set so that their inner side surfaces face opposite each other, is assembled. The thickness of the spacer 14 is equivalent to the thickness of the multilayer optical film 10 as long as the hardening shrinkage and the like of the UV-curable liquid crystal is disregarded. Subsequently, a seal material (not shown) is applied onto the end surfaces of the glass cell except for an area to form a liquid crystal injection port, and thus, the glass cell becomes sealed.

The liquid-state UV-curable liquid crystal is injected into the glass cell through the liquid crystal injection port, and thus, a liquid crystal cell 20 is formed. This UV-curable liquid crystal is prepared by, for instance, mixing monoacrylate and multifunctional acrylate at a specific ratio. The UV-curable liquid crystal assumes orientation along a specific orienting direction. After the UV-curable liquid crystal is injected, the liquid crystal injection port is sealed with an adhesive.

Ultraviolet light fluxes L1 and L2 are radiated onto the front and rear surfaces of the liquid crystal cell 20 into which the UV-curable liquid crystal has been injected. This process is referred to as a first radiation step. The ultraviolet light fluxes L1 and L2 are coherent parallel light beams. The wavelength of the ultraviolet light fluxes L1 and L2 should be within a range of approximately 300 to 400 nm, and such ultraviolet light may be emitted from a light source such as a 407 nm Kr laser.

As interference of the two ultraviolet light fluxes L1 and L2 occurs, numerous interference fringes are formed along a direction perpendicular to the surfaces of the glass substrates 11. Namely, a cyclical light intensity distribution manifests parallel to the surfaces of the glass substrates 11. The UV-curable liquid crystal present in the space where the light intensity is high within the liquid crystal cell 20 becomes hardened while sustaining the initial orientation. The UV-curable liquid crystal present in the space where the light intensity is low within the liquid crystal cell 20 does not undergo polymerization and thus does not become hardened. At this stage, the UV-curable liquid crystal in the liquid crystal cell 20 assumes a structure with a hardened layer (corresponds to the A layer 1) and a liquid state unhardened layer (correspondence to the B layer 2) cyclically layered one on top of the other.

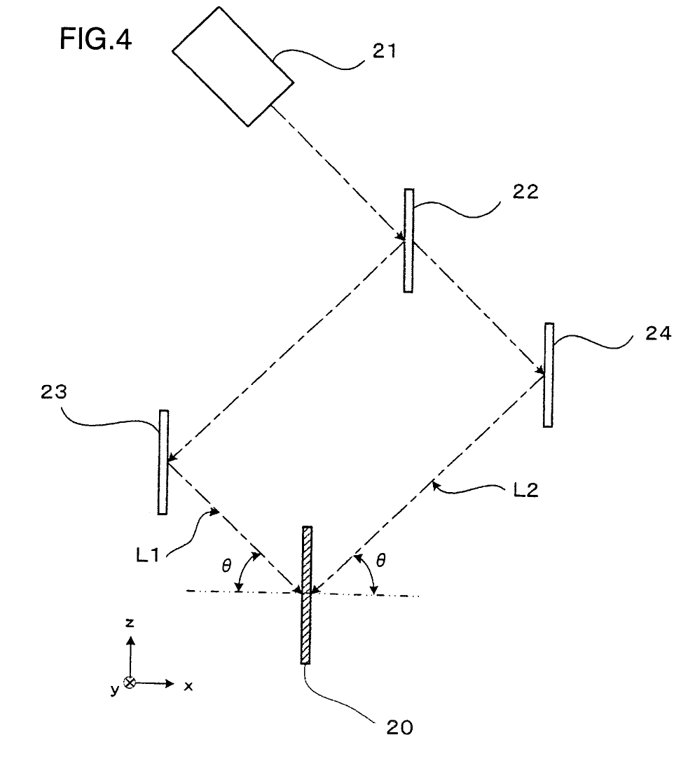

Now, in reference to an interference optical system in FIG. 4, an example of the first radiation step is explained. The ultraviolet light emitted from a laser light source 21 is split into two light fluxes at a half mirror 22. The ultraviolet light L1 having been reflected at the half mirror 22 travels via a mirror 23 before entering one surface of the liquid crystal cell 20 with an angle of incidence E, whereas the ultraviolet light L2 having been transmitted through the half mirror 22 travels via a mirror 24 before it enters the other surface of the liquid crystal cell 20 with the same angle of incidence θ. The position at which the ultraviolet light is split into the ultraviolet light fluxes L1 and L2, i.e., the difference between the optical path lengths of the ultraviolet light fluxes L1 and L2 ranging from the half mirror 22 to the liquid crystal cell 20, is adjusted to match a value that is an integral multiple of the wavelength.

When the A layer 1 in the UV-curable liquid crystal is completely hardened through the first radiation step, a second radiation step is executed. In the second radiation step, the B layer 2, which has not been hardened yet, is hardened.

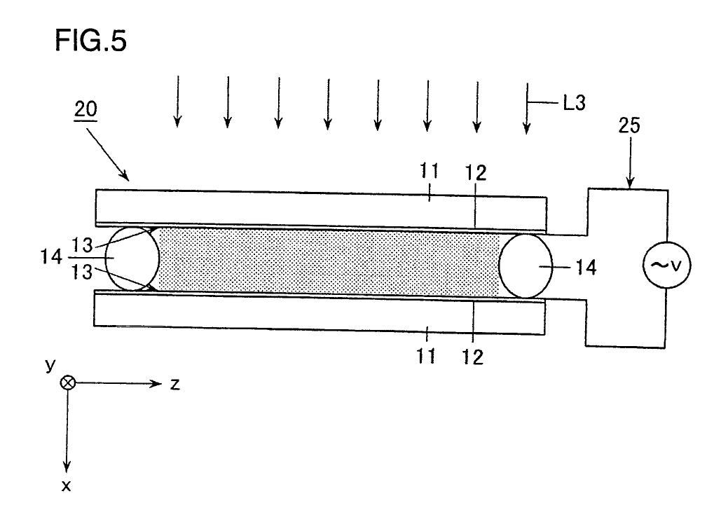

FIG. 5 shows the liquid crystal cell 20 with ultraviolet light L3 radiated thereupon while applying a voltage between the pair of transparent conductive films 12. As a voltage from a power source device 25 is applied between the transparent conductive films 12, the unhardened B layer 2 becomes reoriented along the direction of the electrical field, i.e., along the x direction (see FIG. 1). As the ultraviolet light L3 with a uniform intensity distribution is radiated onto the liquid crystal cell 20 in this state, the liquid crystal molecules in the B layer 2 become hardened while remaining reoriented along the x direction.

After the B layer 2 is hardened, the seal material sealing the end surfaces of the glass cell is removed, the glass cell is disassembled and the multilayer optical film 10 is peeled off the glass substrates 11. The multilayer optical film 10, which includes the A layer 1 and the B layer 2 oriented along directions different from each other and layered one on top of the other reiterativly, is thus obtained. It is to be noted that the ultraviolet light L3 should be non-coherent light that does not manifest interference so as to sustain uniform intensity at the irradiated surface of the glass substrate 11. The ultraviolet light L3 may be radiated on one side of the liquid crystal cell 20 or it may be radiated on the two sides. In addition, the voltage applied between the transparent conductive films 12 may be a DC voltage or it may be an AC voltage with a low frequency of, for instance, approximately 100 Hz.

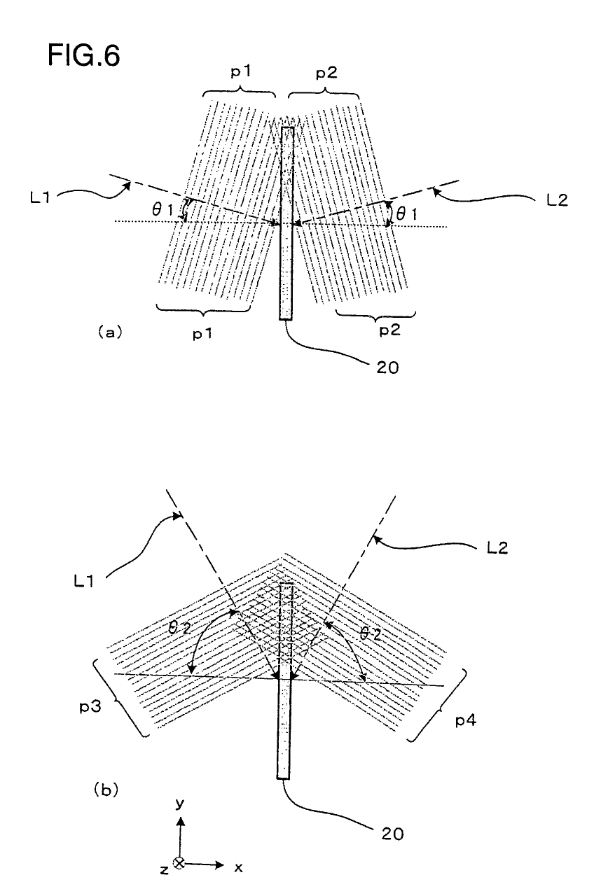

The layer thicknesses of the A layer 1 and the B layer 2 in the first embodiment can be adjusted by varying the angle of incidence θ of the ultraviolet light fluxes L1 and L2 at the liquid crystal cell 20. An explanation is first given in reference to FIGS. 6(a) and 6(b) in qualitative terms. FIG. 6(a) shows a plane wave L1 with a wave front p1 and an angle of incidence θ1 and a plane wave L2 with a wave front p2 and an angle of incidence θ1 entering the liquid crystal cell 20 on the two side surfaces thereof. FIG. 6(b) shows a plane wave L1 with a wave front p3 and an angle of incidence θ2 and a plane wave L2 with the wave front p4 and an angle of incidence θ1 entering the liquid crystal cell 20 from the two surfaces thereof. θ1 is smaller than θ2.

As shown in FIG. 6(a) assuming that the interference of the plane waves L1 and L2 peaks at the intersection of the wave fronts p1 and p2, numerous planes connecting such intersections over the yz planes are cyclically formed along the x direction. These planes constitute the interference fringes mentioned earlier. Likewise, FIG. 6(b) shows numerous planes connecting the intersections of the wave fronts p3 and p4 over the yz plane, which are cyclically formed along the x direction. Since the intervals between the stripes in the interference fringes are in proportion to sin θ, the stripe intervals in FIG. 6(a) are smaller than the stripe intervals in FIG. 6(b).

Next, the ultraviolet light L1 and the ultraviolet light L2 constituted with parallel light fluxes are explained in reference to mathematical expressions. The ultraviolet light fluxes L1 and L2 are respectively expressed as in (1) and (2) below.
r1(x,y)=r·exp(2πiξx) (1)
r2(x,y)r·exp(2πiξ′x) (2)
x and y in expressions (1) and (2) respectively represent the direction along which the thickness of the glass substrates 11 ranges and a direction running parallel to the surfaces of the glass substrates 11. λ indicates the wavelength of the ultraviolet light fluxes L1 and L2. With Ø (Ø=90°, −θ and θ indicate angles of incidence) representing the angle formed by a glass substrate 11 and the vector (directional vector) along the light propagating direction, ε=cos Ø/λ and ε′=cos(n−Ø)/λ are true for expressions (1) and (2).

The intensity I of the light resulting from the interference of the ultraviolet light L1 and the ultraviolet light L2 can be expressed as in (3) below.
I=(r1+r2)²=2r²+2r² exp(2πi(ξ−ξ′)) (3)
the first term in the right side member in (3) represents a stationary background, whereas the second term in the right side member relates to the light intensity in the interference fringes. After calculating the real part in the second term in expression (3), the light intensity Is of the interference fringes can be expressed as in (4) below.
I s=2r² cos(2π·2 cos φ/λ·x) (4)

Expression (4) indicates that the highest light intensity manifests when the ultraviolet light fluxes L1 and L2 enter at a right angle (Ø=90°) and that when Ø=45°, the light intensity is 1/√2 of the light intensity level achieved with perpendicular ultraviolet light beams.

The stripe intervals in the interference fringes are ½ of the wavelength λ when the ultraviolet light enters at a right angle, whereas the stripe intervals are 1/√2 of the wavelength λ when the ultraviolet beams enter at a 45° angle of incidence. For instance, if λ=350 nm, the stripe intervals achieved with perpendicular ultraviolet light beams will be 175 nm and the stripe intervals achieved with ultraviolet light beams entering at an angle of incidence of 45° will be 247 nm. In other words, by varying the angle of incidence θ, the cyclic distribution of the light intensity along the x direction can be varied. Since the stripe intervals in the interference fringes are equal to the layering pitches d with which the A layer 1 and the B layer 2 are layered, the layering pitches d with which the A layer 1 and the B layer 2 are layered one on top of the other, too, can be adjusted by adjusting the stripe intervals in the interference fringes. In addition, the layering pitches d with which the A layer 1 and the B layer 2 are layered one on top of the other can also be adjusted by adjusting the wavelength λ of the ultraviolet light fluxes L1 and L2. When the wavelength λ is smaller, the individual layers assume smaller layer thicknesses, and the layering pitches d assume a smaller value accordingly.

It is to be noted that the layer thickness of the A layer 1 can be controlled by designating at least either the luminance or the length of radiation time of the ultraviolet light fluxes L1 and L2 as a variable. By raising the luminance or lengthening the radiation time while sustaining the angle of incidence θ and the wavelength λ of the ultraviolet light fluxes L1 and L2 at constant settings, an A layer 1 with a large thickness can be formed. By lowering the luminance or shortening the radiation time, on the other hand, an A layer 1 with a small thickness can be obtained. This means that the layer thickness ratio of the A layer 1 and the B layer 2 can be adjusted.

As described above, the multilayer optical film 10 achieving diverse optical characteristics can be manufactured by adjusting the angle of incidence θ or the wavelength X of the ultraviolet light fluxes L1 and L2 or by adjusting the luminance or the length of radiation time of the ultraviolet light. In addition, since the multilayer optical film 10, which is manufactured by using a single UV-curable liquid crystal, is free of any manufacturing error or adverse effect of impurities and thus assures a high optical quality.

### Second Embodiment

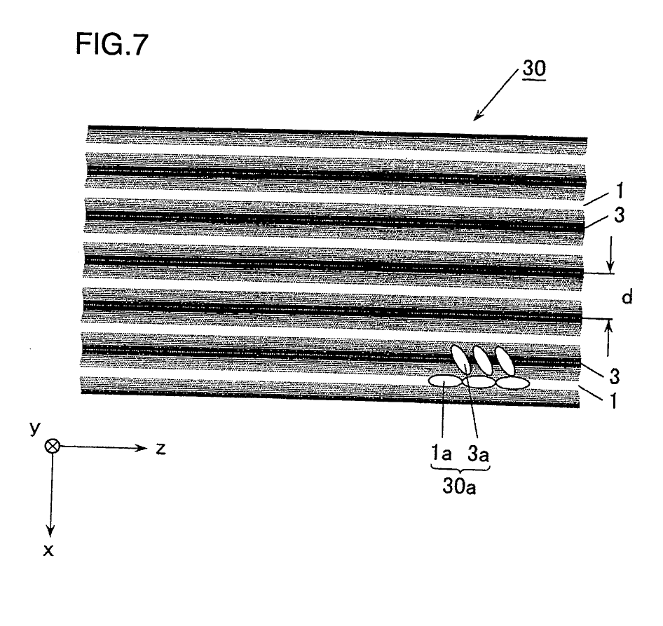

FIG. 7 is a partial sectional view schematically illustrating a multilayer optical film achieved in the second embodiment of the present invention. FIG. 7 shows a multilayer optical film 30 in an orthogonal coordinate system with the thickness of the multilayer optical film 30 indicated along the x-axis.

As shown in FIG. 7, the multilayer optical film 30 achieved in the second embodiment assumes a structure that includes two different types of film layers cyclically layered one on top of the other with layering pitches d, as does the multilayer optical film 10 (see FIG. 1) achieved in the first embodiment. The multilayer optical film 30 differs from the multilayer optical film 10 in that it includes a C layer 3 in place of the B layer 2 in the multilayer optical film 10. Among index ellipsoids 30a, index ellipsoids la in the A layer 1 are oriented so that their major axes extend parallel to the film surface (along the z direction) and index ellipsoids 3a constituting the C layer 3 are oriented so that their major axes extend diagonally relative to the direction along which the film ranges in thickness (along the x direction). As a result, different optical characteristics are achieved in the A layer 1 and the C layer 3, which allows the entire multilayer optical film 30 to manifest optical anisotropy.

When polarized light enters the multilayer optical film 30 in FIG. 7 at a right angle, the multilayer optical film 30 functions as a multilayer film with the A layer 1 with the refractive index nz and the C layer 3 with the refractive index nx1 layered alternately to each other as long as the light is polarized parallel to the z direction, whereas the multilayer optical film 30 functions as a multilayer film that includes the A layer 1 with the refractive index nx and the C layer 3 with the refractive index nx2 layered alternately to each other if the light is polarized parallel to the y direction. Since the major axes of the index ellipsoids 3a in the C layer 3 are oriented diagonally relative to the x direction, the refractive indices nx, nx1 and nx2 assume values different from one another.

Next, the process through which the multilayer optical film 30 in the second embodiment is manufactured is explained. The following explanation focuses on manufacturing steps that distinguish the second embodiment from the first embodiment. The manufacturing process in the second embodiment is identical to the manufacturing process in the first embodiment from the start up to the end of the first radiation step. At the end of the first radiation step, the A layer 1 in the UV-curable liquid crystal will have become hardened. In order to harden the C layer 3, a radiation step is executed within a magnetic field, as explained below instead of the second radiation step executed in the first embodiment.

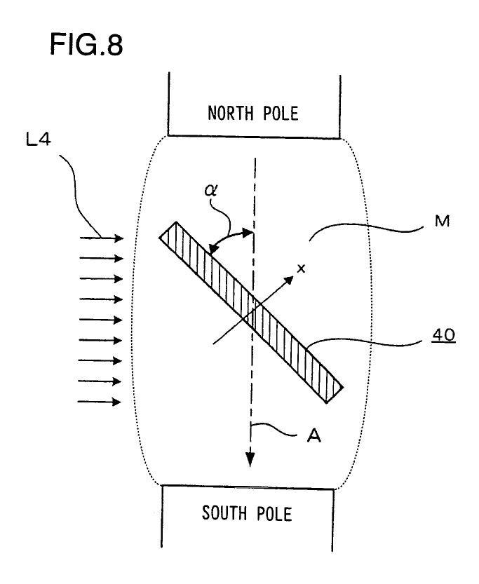

FIG. 8 shows a liquid crystal cell 40 having undergone the first radiation step, which is held in a magnetic field M and irradiated with ultraviolet light L4 of uniform intensity. As the liquid crystal cell 40 is tilted by an angle a relative to the direction (A direction) of the magnetic field, the unhardened C layer 3 in the liquid crystal cell 40 becomes reoriented along a diagonal direction relative to the direction along which the thickness of the liquid crystal cell 40 ranges (along the x direction) in correspondence to the angle of inclination α. As the ultraviolet light L4 with uniform intensity is radiated onto the liquid crystal cell 40 in this state, the C layer 3 becomes hardened with the liquid crystal molecules in the C layer 3 remaining oriented along the new direction.

It is to be noted that the ultraviolet light L4 should be non-coherent light that does not manifest interference so as to sustain uniform intensity at the irradiated surface of the glass substrate at the liquid crystal cell 40. The ultraviolet light L4 may be radiated on one side of the liquid crystal cell 40 or it may be radiated on the two sides. In addition, the magnetic field generation source may be a permanent magnet or an electromagnet.

After the C layer 3 is hardened, the seal material sealing the end surfaces of the glass cell is removed, the glass cell is disassembled and the multilayer optical film 30 is peeled off the glass substrates. The multilayer optical film 30, which includes the A layer land the C layer 3 oriented along directions different from each other and layered one on top of the other reiterativly, is thus obtained.

Operational effects similar to those of the multilayer optical film 10 in the first embodiment are achieved in the multilayer optical film 30 in the second embodiment. In addition, since an electrical field does not need to be applied, the transparent conductive films 12 do not need to be formed in the second embodiment. However, orientation processing must be executed to control the orientation of the A layer 1.

Furthermore, by adjusting the angle of inclination a when hardening the C layer 3, i.e., by selecting a desirable orientation for the magnetic field M relative to the surface of the liquid crystal cell 40, the orientation direction of the liquid crystal molecules in the C layer 3 can be freely controlled in the second embodiment. Thus, the multilayer optical film 30 with desired diverse optical characteristics can be obtained. It is to be noted that by holding the liquid crystal cell 40 within the magnetic field M with an angle of inclination a selected within a range of 0 through 90° and rotating the liquid crystal cell 40 around its normal by a desired degree, a multilayer optical film 30 with even more diverse optical characteristics can be obtained.

The multilayer optical films 10 and 30 in the first and second embodiments are peeled off the glass substrates 11 after the UV-curable liquid crystal hardens. The multilayer optical films 10 and 30 may each be used by itself or they may be disposed onto lenses or filters and used in conjunction with these optical components. In the latter case, the base of a lens or filter may be utilized in place of the glass substrates 11 to allow the film on the lens or the filter to be immediately used as an optical member. The present invention is not limited by any means to the embodiments explained above, as long as its features are retained intact.

As explained above, the multilayer optical films 10 and 30 each assume a multilayer structure achieved by reiterativly layering layer units each constituted with two different types of layers with varying optical anisotropic characteristics. In other words, the multilayer optical films 10 and 30 each constitute a multilayer film optical member achieved by layering liquid crystal layers oriented along different directions over a plurality of stages. The multilayer optical films 10 and 30 may each be used in a polarization beam splitter, at which light enters at a right angle, a polarized light reflecting mirror that achieves a reflectance of substantially 100% for light entering at a right angle or the like. A polarization beam splitter that includes the multilayer optical film 10 is capable of completely separating p polarized light from s polarized light by taking full advantage of the Brewster angle.

As described above, a high-quality multilayer film optical member can be manufactured through a simple process by adopting the first embodiment or the second embodiment.

The disclosure of the following priority application is herein incorporated by reference:
Japanese Patent Application No. 2004-034734 filed Feb. 12, 2004

1. A manufacturing method for manufacturing a multilayer film optical member, comprising:
an injection step in which an UV-curable liquid crystal is injected into a space between a pair of transparent substrates, with a transparent conductive film disposed on each of the transparent substrates;
a first radiation step in which ultraviolet light beams, each ultraviolet light beam being a parallel coherent light beam, are radiated onto the UV-curable liquid crystal through the pair of transparent substrates from two sides of the UV-curable liquid crystal; and
a second radiation step in which ultraviolet light achieving uniform intensity on a surface of the transparent substrate is radiated onto the UV-curable liquid crystal through the transparent substrate while applying an electrical field between the pair of transparent conductive films.

2. A manufacturing method for manufacturing a multilayer film optical member, comprising:
an injection step in which an UV-curable liquid crystal is injected into a space between a pair of transparent substrates;
a first radiation step in which ultraviolet light beams, each ultraviolet light beam being a parallel coherent light beam, are radiated onto the UV-curable liquid crystal through the pair of transparent substrates from two sides of the UV-curable liquid crystal; and
a second radiation step in which ultraviolet light achieving uniform intensity on a surface of the transparent substrate is radiated onto the UV-curable liquid crystal through the transparent substrate while holding in a magnetic field the UV-curable liquid crystal having been injected into the space between the pair of transparent substrates.

3. A manufacturing method for manufacturing a multilayer film optical member according to claim 2, wherein:
the second radiation step is executed by selecting a desired orientation for the magnetic field relative to surfaces of the pair of transparent substrates.

4. A manufacturing method for manufacturing a multilayer film optical member according to claim 1, wherein:
during the first radiation step, an angle of incidence of light radiated onto the UV-curable liquid crystal from one side is set equal to an angle of incidence of light radiated from another side.

5. A manufacturing method for manufacturing a multilayer film optical member according to claim 1, wherein:
the first radiation step is executed by designating one of radiation intensity and a length of radiation time of light radiated onto the UV-curable liquid crystal from one side and one of radiation intensity and a length of radiation time of light radiated from another side as variables.

6. A manufacturing method for manufacturing a multilayer film optical member according to claim 1, wherein:
the ultraviolet light achieving uniform intensity, that is radiated in the second radiation step, is non-coherent light.

7. A manufacturing method for manufacturing a multilayer film optical member according to claim 1, further comprising:
after ending the second radiation step, a separation step in which the multilayer film optical member is separated from the transparent substrates is executed.

8. A multilayer film optical member manufactured through the manufacturing method according to claim 1.

9. A multilayer film optical member, comprising:
a plurality of liquid crystal layers oriented along directions different from one another and layered one on top of another.

10. A multilayer film optical member manufactured through the manufacturing method according to claim 2.

11. A manufacturing method for manufacturing a multilayer film optical member according to claim 1, wherein:
during the first radiation step, an angle of incidence of light radiated onto the UV-curable liquid crystal is adjustable.

12. A manufacturing method for manufacturing a multilayer film optical member according to claim 4, wherein:
during the first radiation step, the angle of incidence of light radiated onto the UV-curable liquid crystal from the one side and the angle of incidence of light radiated from the other side are each adjustable.

13. A multilayer film optical member, comprising:
a plurality of layers formed by hardening a single UV-curable liquid crystal under different hardening conditions and layered cyclically one on top of another.

14. An optical member, comprising:
the multilayer film optical member according to claim 8.

15. An optical member according to claim 14, wherein:
the optical member is a polarization beam splitter.

16. A manufacturing method for manufacturing a multilayer film optical member, comprising:
an injection step in which an UV-curable liquid crystal is injected into a space between a pair of transparent substrates, with a transparent conductive film disposed on each of the transparent substrates;
a first radiation step in which ultraviolet light beams, each ultraviolet light beam being a parallel coherent light beam, are radiated onto the UV-curable liquid crystal through the pair of transparent substrates from two sides of the UV-curable liquid crystal;
an application step in which an electrical field is applied between the pair of transparent conductive films; and
a second radiation step in which ultraviolet light achieving uniform intensity on a surface of the transparent substrate is radiated onto the UV-curable liquid crystal through the transparent substrate.

17. A manufacturing method for manufacturing a multilayer film optical member according to claim 16, further comprising:
an orientation step in which orientation processing is executed on the pair of transparent substrates, wherein:
the first radiation step is executed while the UV-curable liquid crystal is oriented by the pair of transparent substrates on which the orientation processing is executed in the orientation step.

18. A manufacturing method for manufacturing a multilayer film optical member, comprising:
an injection step in which an UV-curable liquid crystal is injected into a space between a pair of transparent substrates;
a first radiation step in which ultraviolet light beams, each ultraviolet light beam being a parallel coherent light beam, are radiated onto the UV-curable liquid crystal through the pair of transparent substrates from two sides of the UV-curable liquid crystal;
a holding step in which the UV-curable liquid crystal having been injected into the space between the pair of transparent substrates is held in a magnetic field; and
a second radiation step in which ultraviolet light achieving uniform intensity on a surface of the transparent substrate is radiated onto the UV-curable liquid crystal through the transparent substrate.

19. A manufacturing method for manufacturing a multilayer film optical member according to claim 18, further comprising:
an orientation step in which orientation processing is executed on the pair of transparent substrates, wherein:
the first radiation step is executed while the UV-curable liquid crystal is oriented by the pair of transparent substrates on which the orientation processing is executed in the orientation step.
